(19) United States
(12) Patent Application Publication
(10) Pub. No.: US 2026/0211373 A1
(43) Pub. Date: Jul. 23, 2026

(54) TIMEPIECE COMPONENT, TIMEPIECE MOVEMENT, TIMEPIECE, AND METHOD FOR MANUFACTURING TIMEPIECE COMPONENT

(71) Applicant: SEIKO WATCH KABUSHIKI KAISHA (trading as SEIKO WATCH CORPORATION, Tokyo (JP)

(72) Inventors: Kazuki HAYAKAWA, Tokyo (JP); Hisashi FUJIEDA, Tokyo (JP); Masahiro NAKAJIMA, Tokyo (JP)

(21) Appl. No.: 19/445,179

(22) Filed: Jan. 9, 2026

(30) Foreign Application Priority Data
Jan. 20, 2025 (JP) 2025-007674
Nov. 12, 2025 (JP) 2025-191734

(51) Int. Cl. G04B 17/06

(52) U.S. Cl. CPC G04B 17/063; G04B 17/066

(57) ABSTRACT

Provided is a timepiece component in which a paramagnetic hairspring is welded to a collet with high strength. A timepiece component includes a collet fixed to a balance staff, a hairspring formed of a paramagnetic material and including an inner end portion fixed to the collet, and a melting portion in which the collet and the hairspring are melted to fix the collet and the inner end portion to each other. The melting portion includes a first melting portion provided at a position on a first side in an axial direction with respect to the inner end portion, and a second melting portion provided at a position on a second side in the axial direction with respect to the inner end portion.

### RELATED APPLICATIONS

This application claims priority to Japanese Patent application Nos. JP2025-007674, filed on Jan. 20, 2025, and JP 2025-191734, filed on Nov. 12, 2025, the entire content of which is incorporated herein by reference.

### BACKGROUND OF THE INVENTION

### 1. Field of the Invention

The present invention relates to a timepiece component, a timepiece movement, a timepiece, and a method for manufacturing a timepiece component.

### 2. Description of the Related Art

A mechanical timepiece includes an escapement and speed control mechanism for controlling rotation of a movement barrel complete, a center wheel and pinion, a third wheel and pinion, and a fourth wheel and pinion constituting a front train wheel. A general escapement and speed control mechanism includes an escape wheel and pinion and a balance with hairspring. The balance with hairspring includes a balance wheel, a balance staff, a hairspring, and a collet. The balance staff serves as a rotation center of the balance wheel. The collet is fixed to the balance staff. An inner end of a spiral hairspring is fixed to the collet. The hairspring rotates the balance wheel back and forth by expansion and contraction. A configuration in which a hairspring is fixed to a collet by welding is known (for example, see JP7007109B and Switzerland Patent Application Publication No. 468662).

It is desired to improve the welding strength of the collet and the hairspring. As a welding method of the collet and the hairspring, laser-welding may be used. In this case, when an amount of heat input is increased to increase a melting range, the hairspring generally has an elongated cross-sectional shape compared to the collet, and the thermal resistance is also large. Therefore, the periphery of a welding point is intensively heated, and a crystal is likely to be coarsened. The coarsening of the crystal of a metal material tends to cause a decrease in strength, but in particular, a paramagnetic material such as a niobium alloy tends to cause grain boundary fracture due to the coarsening of the crystal. For this reason, the hairspring made of a niobium alloy is likely to be broken due to the coarsening of the crystal, and the strength is significantly reduced. Therefore, when the collet and the hairspring are laser-welded, it is necessary to limit the amount of heat input to the hairspring to reduce a decrease in strength of the hairspring itself.

In the hairspring made of a niobium alloy, since a melting point of the niobium alloy is high and the amount of heat input is limited, it is difficult to form a welded portion deeper than that of a hairspring made of an elinvar. Therefore, the welding strength may decrease due to stress concentration caused by a wedge effect.

Further, a paramagnetic material such as a niobium alloy is used as a hairspring by forming a film of an oxide or the like on a surface for temperature compensation. When such a paramagnetic hairspring is welded to the collet, the wedge effect is further enhanced due to the oxide accumulating at an end of a melting portion, and the welding strength is likely to decrease.

JP7007109B discloses an invention for improving an adhesion strength of a hairspring by setting a plurality of welding points of a hairspring and a collet. However, JP7007109B does not disclose or suggest any decrease in welding strength due to the wedge effect, and an effect of improving the adhesion strength of a hairspring according to the invention described in JP7007109B is limited.

Switzerland Patent Application Publication No. 468662 discloses that a collet has an eaves shape covering a hairspring from both upper and lower sides, and the collet and the hairspring are fixed by a method including welding. However, Switzerland Patent Application Publication No. 468662 does not disclose a condition suitable for laser-welding of a paramagnetic hairspring having a film on a surface. In the invention described in Switzerland Patent Application Publication No. 468662, the hairspring is fixed at a plurality of positions over the entire circumference of the collet, and there is room for improvement in productivity.

### SUMMARY OF THE INVENTION

It is an aspect of the present application to provide a timepiece component in which a paramagnetic hairspring is welded to a collet with high strength, a timepiece movement, a timepiece, and a method for manufacturing a timepiece component.

A timepiece component according to a first aspect of the application includes: a collet fixed to a balance staff; a hairspring formed of a paramagnetic material and including a fixed portion fixed to the collet; and a melting portion in which the collet and the hairspring are melted to fix the collet and the fixed portion to each other. The melting portion includes a first melting portion provided at a position on a first side in an axial direction with respect to the fixed portion, and a second melting portion provided at a position on a second side in the axial direction with respect to the fixed portion.

According to the first aspect, the hairspring is fixed to the collet on both sides in the axial direction. Accordingly, compared to a configuration in which a hairspring is fixed to a collet by a single melting portion, it is possible to increase a volume of the entire melting portion while reducing an amount of heat input to the hairspring when forming each of the first melting portion and the second melting portion. Accordingly, it is possible to improve the welding strength of the hairspring and the collet while reducing a decrease in strength of the hairspring itself.

Further, since the melting portion is provided on both sides of the hairspring in the axial direction, even if a size of each of the first melting portion and the second melting portion in the axial direction is small, it is possible to reduce a decrease in welding strength due to the wedge effect. Therefore, it is possible to adopt a configuration suitable for a case where the amount of heat input is limited when the melting portion is formed.

In addition, since the melting portion is provided on both sides of the hairspring in the axial direction, it is possible to effectively reduce a decrease in welding strength even when a film of the paramagnetic hairspring accumulates at an end of the melting portion and a wedge effect is enhanced.

As described above, it is possible to provide a timepiece component in which a paramagnetic hairspring is welded to a collet with high strength.

According to a second aspect of the application, in the timepiece component according to the first aspect, an oxide film may be formed on an outer surface of the hairspring.

According to the second aspect, although the oxide film can be accumulated at an end of the melting portion, even if the accumulated oxide acts to enhance the wedge effect, it is possible to reduce a decrease in welding strength of the hairspring and the collet by providing the melting portion on both sides of the hairspring in the axial direction.

According to a third aspect of the application, in the timepiece component according to the first aspect or the second aspect, the first melting portion and the second melting portion may be separated from each other in the axial direction.

According to the third aspect, since the fixed portion of the hairspring is not divided by the melting portion, the melting portion serves as an anchor in the hairspring extending in a circumferential direction, and in particular, the strength of the hairspring in a longitudinal direction can be improved.

According to a fourth aspect of the application, in the timepiece component according to any one of the first to third aspects, the melting portion is provided at one location in a circumferential direction with respect to the collet, and the first melting portion and the second melting portion are each continuous in the circumferential direction.

According to the fourth aspect, since each of the first melting portion and the second melting portion can be formed by one-time welding, it is possible to obtain a timepiece component having excellent productivity.

In a configuration in which the melting portions are provided at a plurality of locations in the circumferential direction, the required welding strength of the hairspring and the collet can be ensured by being divided into a plurality of melting portions. On the other hand, in the fourth aspect, since the melting portion is provided at only one location in the circumferential direction, it is necessary to secure the welding strength necessary for a melting portion at one location. Therefore, an effect of improving the welding strength of the hairspring and the collet can be effectively exhibited.

According to a fifth aspect of the application, in the timepiece component according to any one of the first to fourth aspects, the melting portion is located at a position opposite to the collet with the fixed portion interposed therebetween.

According to the fifth aspect, the fixed portion of the hairspring can be restricted from being displaced in a direction away from the collet by the melting portion, and the hairspring can be prevented from falling off from the collet. Therefore, an effect of firmly fixing the hairspring to the collet can be effectively exhibited.

According to a sixth aspect of the application, in the timepiece component according to any one of the first to fifth aspects, the fixed portion may have a gap in a radial direction with respect to the collet.

In the sixth aspect, compared to a configuration in which the fixed portion is in contact with the collet, there is room for the fixed portion to be displaced with respect to the collet, and the fixed portion is likely to fall off from the collet. Therefore, the application is suitable for the above-described configuration in which the welding strength of the hairspring and the collet can be improved to firmly fix the hairspring to the collet.

According to a seventh aspect of the application, in the timepiece component according to any one of the second aspect or an aspect citing the second aspect, the timepiece component may further include an aggregate formed of the oxide film and covered with the melting portion.

According to the seventh aspect, even if the aggregate covered with the melting portion acts to enhance the wedge effect, it is possible to reduce a decrease in welding strength of the hairspring and the collet by providing the melting portion on both sides of the hairspring in the axial direction.

According to an eighth aspect of the application, in the timepiece component according to any one of the first to seventh aspects, the collet may include a main body extending along a circumferential direction around the balance staff, and a gap defining both ends of the main body in the circumferential direction is formed in the collet.

According to the eighth aspect, by providing the gap in the collet in which the interference is set with respect to the balance staff, a pulling force and a loosening torque can be reduced to appropriate values. Therefore, the collet can be easily attached to the balance staff, and the productivity of the timepiece movement including the timepiece component can be improved.

According to a ninth aspect of the application, in the timepiece component according to the eighth aspect, the gap may be shifted with respect to the melting portion around the balance staff and may be located at a position shifted by a predetermined angle from 180° with respect to the melting portion.

When the collet provided with the gap is fixed to the balance staff, the collet may be eccentric to a side opposite to the gap with respect to the balance staff, which is a rotation center thereof. According to the ninth aspect, even when the collet is eccentric to the rotation center, the fixed portion of the hairspring is less likely to be displaced in the radial direction. Accordingly, it is possible to prevent occurrence of an error in isochronism of the hairspring. Further, since the gap is provided to avoid the melting portion, the stress generated in the collet when the collet is fixed to the balance staff is unlikely to affect the melting portion. Therefore, it is possible to reduce a decrease in a fixing force of the collet and the hairspring in the melting portion.

According to a tenth aspect of the application, in the timepiece component according to the eighth aspect or the ninth aspect, the collet may have a polygonal shape when viewed from the axial direction.

According to the tenth aspect, since the collet is easily formed into a desired shape, a center of gravity of the collet can be easily adjusted.

A timepiece movement according to an eleventh aspect of the application includes the timepiece component according to any one of the first to tenth aspects.

According to the eleventh aspect, since the paramagnetic hairspring is welded to the collet with high strength, it is possible to provide a highly reliable timepiece movement in which breakage of the balance with hairspring is prevented.

A timepiece according to a twelfth aspect of the application includes the timepiece movement according to the eleventh aspect.

According to the twelfth aspect, a highly reliable timepiece can be provided.

A method for manufacturing a timepiece component according to a thirteenth aspect of the application is a method for manufacturing a timepiece component including a collet fixed to a balance staff and a hairspring fixed to the collet, and the method includes: forming the hairspring using a paramagnetic material; providing, on the collet, a pair of eaves portions facing the hairspring from both sides in an axial direction; and fixing the collet and the hairspring to each other by melting the collet and the eaves portions by laser-welding the pair of eaves portions and the hairspring.

According to the thirteenth aspect, the melting portions in which each eaves portion and the hairspring are melted are formed on both sides of the hairspring in the axial direction. Accordingly, compared to a configuration in which only one location of the hairspring and the collet are laser-welded, it is possible to increase a volume of the entire melting portion while reducing an amount of heat input when eaves portions are laser-welded. Accordingly, it is possible to improve the welding strength of the hairspring and the collet while reducing a decrease in strength of the hairspring itself.

Further, since the melting portion is provided on both sides of the hairspring in the axial direction, even if the size of each melting portion in the axial direction is small, it is possible to reduce a decrease in welding strength due to the wedge effect. Therefore, it is possible to adopt a configuration suitable for a case where the amount of heat input is limited when the melting portion is formed.

In addition, since the melting portion is provided on both sides of the hairspring in the axial direction, it is possible to effectively suppress a decrease in welding strength even when a film of the paramagnetic hairspring accumulates at an end of the melting portion and a wedge effect is enhanced.

As described above, the paramagnetic hairspring can be welded to the collet with high strength.

According to the present application, it is possible to provide a timepiece component in which a paramagnetic hairspring is welded to a collet with high strength, a timepiece movement, a timepiece, and a method for manufacturing a timepiece component.

### BRIEF DESCRIPTION OF THE DRAWINGS

FIG. 1 is an appearance diagram of a timepiece according to a first embodiment.

FIG. 2 is a plan view of a movement according to the first embodiment.

FIG. 3 is a plan view of a balance with hairspring according to the first embodiment.

FIG. 4 is a plan view showing a part of a timepiece component according to the first embodiment.

FIG. 5 is a cross-sectional view taken along a line V-V in FIG. 4.

FIG. 6 is a perspective view of a collet before welding according to the first embodiment.

FIG. 7 is a plan view showing a state before welding of a hairspring and the collet according to the first embodiment.

FIG. 8 is a cross-sectional view taken along a line VIII-VIII in FIG. 7.

FIG. 9 is a cross-sectional view of a timepiece component according to a modification of the first embodiment, and is a view corresponding to FIG. 5.

FIG. 10 is a longitudinal sectional view of a collet according to a second embodiment.

FIG. 11 is a plan view of a balance with hairspring according to a third embodiment.

FIG. 12 is a plan view of a balance with hairspring according to a first modification of the third embodiment.

FIG. 13 is a plan view of a balance with hairspring according to a second modification of the third embodiment.

FIG. 14 is a plan view of a balance with hairspring according to a fourth embodiment.

FIG. 15 is a plan view of a balance with hairspring according to a modification of the fourth embodiment.

### DETAILED DESCRIPTION OF THE PREFERRED EMBODIMENTS

Hereinafter, embodiments of the invention will be described with reference to the drawings. In the following description, configurations having the same or similar functions are denoted by the same reference signs. A redundant description of the configuration may be omitted.

### First Embodiment

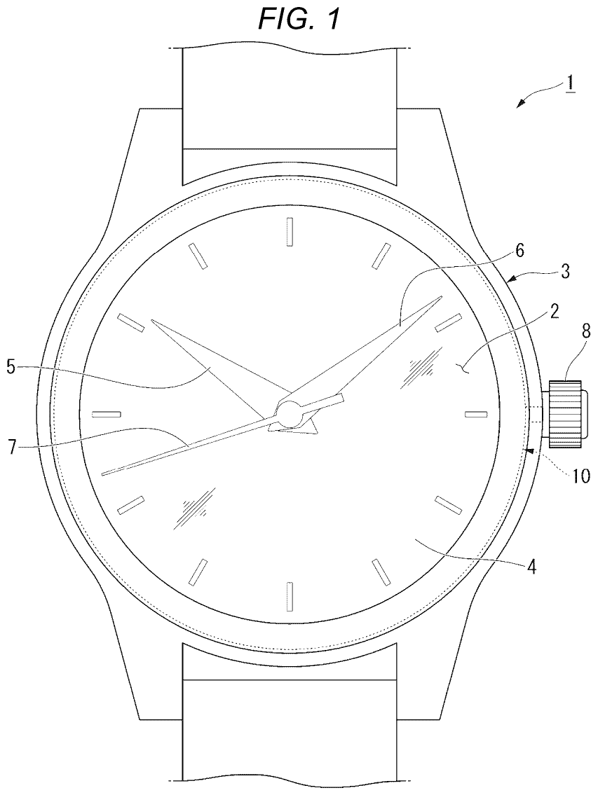

FIG. 1 is an appearance diagram of a timepiece according to a first embodiment.

As shown in FIG. 1, a timepiece 1 according to the present embodiment includes a movement (a timepiece movement) 10, a dial 4 having a scale indicating at least information on the hour, and hands including an hour hand 5 indicating the hours, a minute hand 6 indicating the minutes, and a seconds hand 7 indicating the seconds, all housed within a timepiece case 3 including a case back and a glass 2 (not shown).

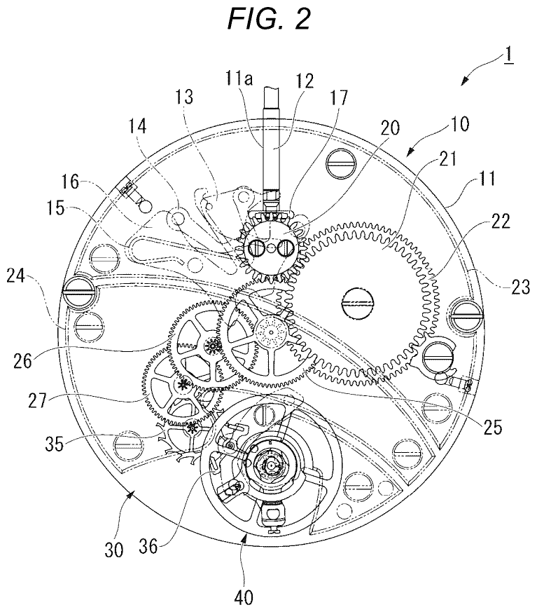

FIG. 2 is a plan view of a movement according to the first embodiment.

As shown in FIG. 2, the movement 10 includes a main plate 11 forming a substrate. A winding stem guide hole 11a is formed in the main plate 11. A winding stem 12 coupled to a crown 8 shown in FIG. 1 is rotatably incorporated in the winding stem guide hole 11a. A position of the winding stem 12 in the axial direction is determined by a switching device including a setting lever 13, a yoke 14, a yoke spring 15 and a setting lever jumper 16. A winding pinion 17 is rotatably provided on a guide shaft portion of the winding stem 12.

When the winding stem 12 is rotated in such a configuration, the winding pinion 17 rotates via rotation of a clutch wheel (not shown). When the winding pinion 17 rotates, a crown wheel 20 and a ratchet wheel 21 rotate in this order, and a mainspring (not shown) housed in a movement barrel complete 22 is wound up. The movement barrel complete 22 is pivotally supported between the main plate 11 and a barrel bridge 23.

A center wheel and pinion 25, a third wheel and pinion 26, a fourth wheel and pinion 27, and an escape wheel and pinion 35 are pivotally supported between the main plate 11 and a train wheel bridge 24. When the movement barrel complete 22 rotates due to a restoring force of the mainspring, the center wheel and pinion 25, the third wheel and pinion 26, and the fourth wheel and pinion 27 rotate in order. The movement barrel complete 22, the center wheel and pinion 25, the third wheel and pinion 26, and the fourth wheel and pinion 27 form a front train wheel.

When the center wheel and pinion 25 rotates, a cannon pinion (not shown) rotates based on the rotation, and the minute hand 6 (see FIG. 1) attached to the cannon pinion displays the “minutes”. When the cannon pinion rotates, an hour wheel (not shown) rotates via a minute wheel (not shown), and the hour hand 5 (see FIG. 1) attached to the hour wheel displays the “hours”. When the fourth wheel and pinion 27 rotates, the seconds hand 7 (see FIG. 1) attached to a second wheel linked with the fourth wheel and pinion 27 displays the “seconds”.

An escapement and speed control mechanism 30 for controlling the rotation of the front train wheel is disposed on a front side of the movement 10. The escapement and speed control mechanism 30 includes the escape wheel and pinion 35 that meshes with the fourth wheel and pinion 27, a pallet fork 36 that causes the escape wheel and pinion 35 to escape and rotate regularly, and a balance with hairspring 40. Hereinafter, the structure of the balance with hairspring 40 will be described in detail below.

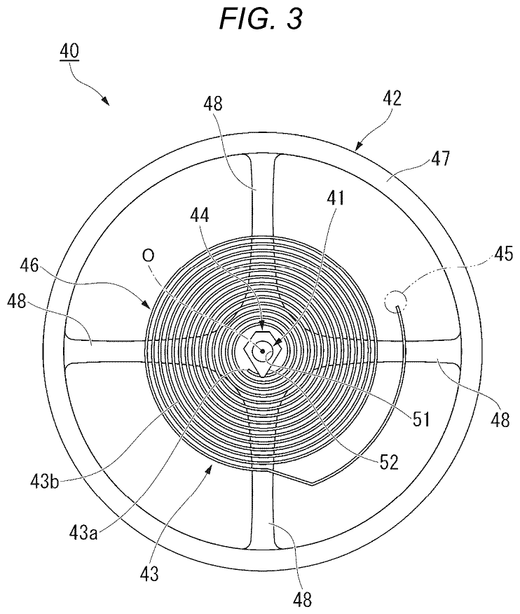

FIG. 3 is a plan view of a balance with hairspring according to the first embodiment.

As shown in FIG. 3, the balance with hairspring 40 includes a balance staff 41, a balance wheel 42, a hairspring 43, and a collet 44. The balance with hairspring 40 reciprocally rotates (rotates forward and backward) around a central axis O of the balance staff 41 at a constant oscillation cycle (oscillation angle) by using power of the hairspring 43. In the present embodiment, a direction along the central axis O of the balance staff 41 is referred to as an axial direction, a direction orthogonal to the central axis O and extending radially from the central axis O is referred to as a radial direction, and a direction around the central axis O in a plan view viewed from the axial direction is referred to as a circumferential direction.

The balance staff 41 is formed of a metal material such as brass, and is a rod-shaped member extending along a central axis O. Both ends of the balance staff 41 in the axial direction are pivotally supported between the main plate 11 and a balance bridge (not shown).

The balance wheel 42 includes an annular rim portion 47 that surrounds the balance staff 41 from the outside in the radial direction, and arm portions 48 that couple the rim portion 47 and the balance staff 41 in the radial direction. The rim portion 47 is disposed coaxially with the central axis O. The rim portion 47 is formed of a metal material such as brass. A plurality of arm portions 48 extend in the radial direction and are disposed at intervals in the circumferential direction. In the shown example, four arm portions 48 are disposed at intervals of 90 degrees around the central axis O. However, the number, the disposition, and the shape of the arm portions 48 are not limited to this case.

Outer end portions of the arm portions 48 in the radial direction are integrally coupled to an inner peripheral portion of the rim portion 47. Inner end portions of the arm portions 48 in the radial direction are connected to each other and integrated. A substantially central portion of the balance staff 41 in the axial direction is fixed to a coupling portion in which the inner end portions of the arm portions 48 are integrated. Accordingly, the balance staff 41 and the balance wheel 42 are fixed to each other to form a timepiece component 46.

The hairspring 43 is a thin plate spring formed of a metal material. The metal material forming the hairspring 43 is a paramagnetic material and is a niobium alloy in the present embodiment. An oxide film may be formed on an outer surface of the hairspring 43. The hairspring 43 is formed in a spiral shape in a plane orthogonal to the central axis O. An inner end portion 43a of the hairspring 43 is connected to the balance staff 41 via the collet 44.

The hairspring 43 extends along an Archimedes curve when viewed from the axial direction around the central axis O except for the outermost peripheral portion thereof. The hairspring 43 extends along an Archimedes curve having the central axis O as a polar coordinate origin when viewed from the axial direction with the inner end portion 43a as an unwinding position. The outermost peripheral portion of the hairspring 43 extends to be shifted outward in the radial direction from the Archimedes curve. An outer end portion of the hairspring 43 is fixed to a stud 45 attached via a stud support (not shown). Hereinafter, a portion of the hairspring 43 extending along the Archimedes curve between the inner end portion 43a and the outermost peripheral portion is referred to as a main portion 43b. A size of the hairspring 43 in the axial direction is referred to as a width, and a size in the radial direction is referred to as a thickness.

The collet 44 is disposed inside the hairspring 43. The collet 44 has a thickness in the axial direction. The collet 44 is formed of, for example, stainless steel, nickel, or a nickel-iron alloy. The collet 44 is formed by, for example, lathe machining or LIGA.

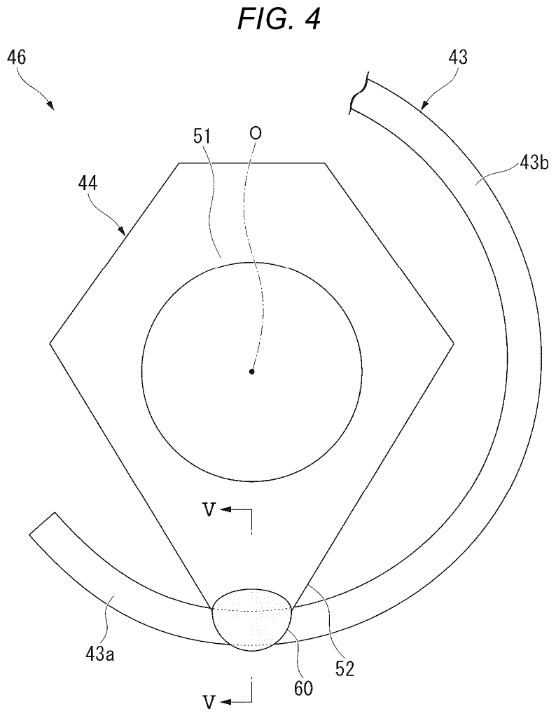

FIG. 4 is a plan view showing a part of a timepiece component according to the first embodiment.

As shown in FIG. 4, the collet 44 has an annular shape surrounding the balance staff 41 (see FIG. 3). The collet 44 includes an outer fitting fixing portion 51 and a single support portion 52. The outer fitting fixing portion 51 has an opening that can be externally fitted to the balance staff 41 and is fixed to the balance staff 41 (also see FIG. 3). The support portion 52 protrudes outward in the radial direction from the outer fitting fixing portion 51. The support portion 52 is tapered outward in the radial direction when viewed from the axial direction. An outer shape of the collet 44 is a polygonal shape (pentagonal shape) having the support portion 52 as one vertex when viewed from the axial direction. The support portion 52 is provided at only one location in the circumferential direction. The support portion 52 supports the inner end portion 43a of the hairspring 43. The inner end portion 43a of the hairspring 43 is an example of a “fixed portion” fixed to the collet 44.

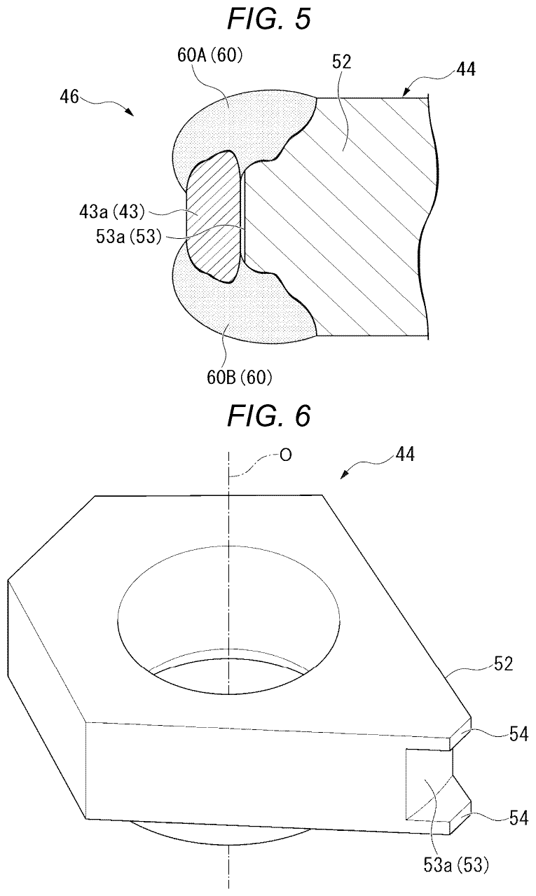

FIG. 5 is a cross-sectional view taken along a line V-V in FIG. 4.

As shown in FIG. 5, the support portion 52 includes a base portion 53 that faces an inner peripheral surface of the inner end portion 43a of the hairspring 43. The base portion 53 has a gap in the radial direction with respect to the hairspring 43. The gap between the base portion 53 and the hairspring 43 may be provided only in a part in the circumferential direction. However, the base portion 53 may be disposed without a gap with respect to the hairspring 43.

As shown in FIGS. 4 and 5, a melting portion 60 that fixes the inner end portion 43a of the hairspring 43 and the collet 44 to each other is connected to the support portion 52. The melting portion 60 is a portion where the hairspring 43 and the collet 44 are melted and alloyed. The melting portion 60 includes a first melting portion 60A provided at a position on a first side in the axial direction with respect to the inner end portion 43a of the hairspring 43, and a second melting portion 60B provided at a position on a second side in the axial direction with respect to the inner end portion 43a of the hairspring 43.

The first melting portion 60A and the second melting portion 60B overlap each other in the axial direction. The first melting portion 60A and the second melting portion 60B are continuous over the entire length in the circumferential direction. The first melting portion 60A and the second melting portion 60B are separated from each other in the axial direction. A part of the inner end portion 43a of the hairspring 43 and a part of the support portion 52 are disposed between the first melting portion 60A and the second melting portion 60B while substantially keeping their original shapes. A width of a portion of the hairspring 43 located between the first melting portion 60A and the second melting portion 60B is smaller than a width of the main portion 43b.

The first melting portion 60A and the second melting portion 60B are continuously disposed from a region on an outer side in the axial direction of the inner end portion 43a of the hairspring 43 to a region on an outer side in the radial direction of the inner end portion 43a of the hairspring 43. That is, the first melting portion 60A and the second melting portion 60B are located at positions opposite to the support portion 52 of the collet 44 with the inner end portion 43a of the hairspring 43 interposed therebetween and overlap the inner end portion 43a of the hairspring 43 when viewed from an outside in the radial direction. Further, the first melting portion 60A and the second melting portion 60B extend to an inner side in the radial direction from the region on the outer side in the axial direction of the inner end portion 43a of the hairspring 43. The first melting portion 60A and the second melting portion 60B are continuously disposed from the region on the outer side in the axial direction of the inner end portion 43a of the hairspring 43 to a region on an inner side in the radial direction of the inner end portion 43a of the hairspring 43. However, at least one of the first melting portion 60A and the second melting portion 60B may not be disposed in the region on the inner side in the radial direction of the inner end portion 43a of the hairspring 43.

Here, a method for manufacturing the timepiece component 46 will be described.

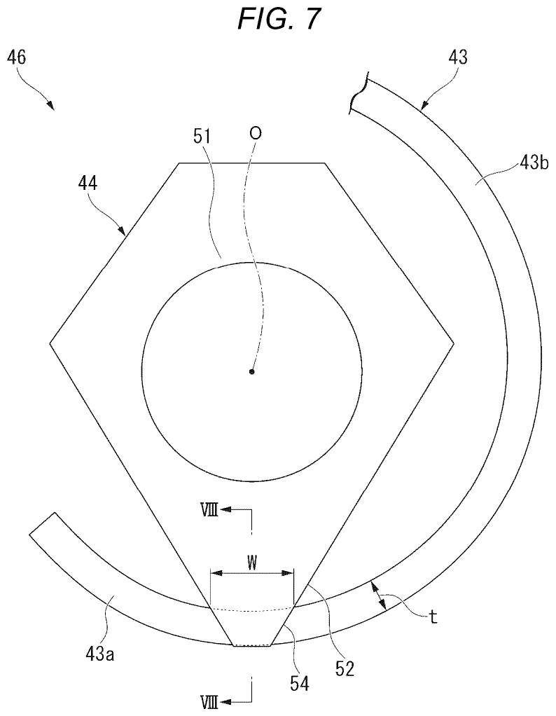

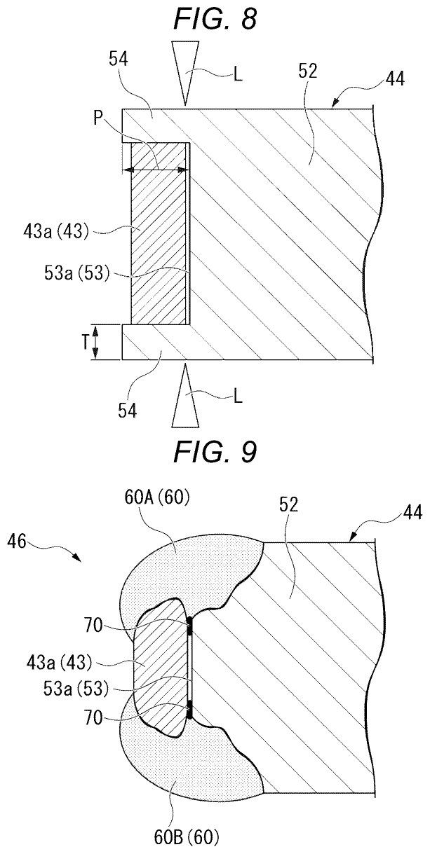

FIG. 6 is a perspective view of a collet before welding according to the first embodiment. FIG. 7 is a plan view showing a state before welding of a hairspring and the collet according to the first embodiment. FIG. 8 is a cross-sectional view taken along a line VIII-VIII in FIG. 7.

As shown in FIGS. 6 to 8, the support portion 52 of the collet 44 before welding includes a base portion 53 and a pair of eaves portions 54. The base portion 53 includes a support surface 53a facing outward in the radial direction. The support surface 53a is parallel to the axial direction. The support surface 53a faces the inner peripheral surface of the inner end portion 43a of the hairspring 43 over the entire width in the axial direction. The support surface 53a extends along a shape of the inner end portion 43a of the hairspring 43. For example, the support surface 53a may extend in an arc shape or may extend along the Archimedes curve. However, the support surface 53a may be a flat surface.

The pair of eaves portions 54 protrude outward in the radial direction from the base portion 53. The pair of eaves portions 54 are provided at locations on an outer side in the axial direction of the support surface 53a in the support portion 52 and protrude outward in the radial direction from the support surface 53a. An interval between the pair of eaves portions 54 is equal to a width in the axial direction of the inner end portion 43a of the hairspring 43. The pair of eaves portions 54 have the same shape and overlap each other when viewed from the axial direction. Each of the eaves portions 54 is tapered outward in the radial direction when viewed from the axial direction. A width W in the circumferential direction at a base end portion of the eaves portion 54 is desirably 2 times or more and 10 times or less a thickness t of the hairspring 43. A thickness T of each eaves portion 54 is preferably 0.5 times or more and 2 times or less the thickness t of the hairspring 43. A protruding length P of the eaves portion 54 in the radial direction with respect to the support surface 53a is desirably 70% or more of the thickness t of the hairspring 43.

As shown in FIGS. 7 and 8, when the collet 44 and the hairspring 43 are welded, the inner end portion 43a of the hairspring 43 is disposed between the pair of eaves portions 54. The inner end portion 43a of the hairspring 43 is disposed along the support surface 53a of the collet 44. In the shown example, the inner end portion 43a of the hairspring 43 is disposed with a gap from the support surface 53a of the collet 44 in the radial direction. However, at least a part of the inner end portion 43a of the hairspring 43 may be in contact with the support surface 53a of the collet 44. At this time, the eaves portion 54 desirably covers 70% or more of the inner end portion 43a of the hairspring 43 in a thickness direction (radial direction) of the inner end portion 43a when viewed from the axial direction. In the present embodiment, the protruding length P of the eaves portion 54 is larger than the thickness t of the hairspring 43, and the eaves portion 54 covers the inner end portion 43a of the hairspring 43 over the entire length in the thickness direction of the inner end portion 43a when viewed from the axial direction. End edges on both sides in the axial direction of the inner end portion 43a of the hairspring 43 approach or come into contact with the eaves portions 54 from the inside in the axial direction.

In this state, the collet 44 and the hairspring 43 are laser-welded by irradiating the support portion 52 of the collet 44 with lasers to input heat to the eaves portions 54. A laser light L is emitted toward the collet 44 from both outer sides in the axial direction. For example, a spot of the laser light L may be emitted only to the eaves portion 54 or may be emitted only to the base portion 53 or a region extending from the base portion 53 to the eaves portion 54. However, it is desirable that the laser light L is not emitted to the hairspring 43.

When heat is input to the eaves portion 54, the eaves portion 54 and a portion of the hairspring 43 close to the eaves portion 54 are melted and alloyed to form the melting portion 60. In the present embodiment, the entire eaves portion 54 is transformed into the melting portion 60 and disappears. However, only a part of the eaves portion 54 may be modified into the melting portion 60. By forming the melting portion 60, both end edges in the axial direction of the inner end portion 43a of the hairspring 43 retreat inward in the axial direction. For example, a portion having the largest retraction distance of both end edges in the axial direction of the inner end portion 43a of the hairspring 43 retracts inward in the axial direction by a distance of 15% or more and less than 50% of the width of the main portion 43b of the hairspring 43 with respect to the end edge in the axial direction of the main portion 43b of the hairspring 43.

As described above, the timepiece component 46 according to the present embodiment includes the melting portion 60 in which the collet 44 and the hairspring 43 are melted to fix the collet 44 and the inner end portion 43a to each other. The melting portion 60 includes the first melting portion 60A provided at a position on the first side in the axial direction with respect to the inner end portion 43a, and the second melting portion 60B provided at a position on the second side in the axial direction with respect to the inner end portion 43a. According to this configuration, the hairspring 43 is fixed to the collet 44 on both sides in the axial direction. Accordingly, compared to a configuration in which a hairspring is fixed to a collet by a single melting portion, it is possible to increase a volume of the entire melting portion 60 while reducing an amount of heat input to the hairspring 43 when forming each of the first melting portion 60A and the second melting portion 60B. Accordingly, it is possible to improve the welding strength of the hairspring 43 and the collet 44 while reducing a decrease in strength of the hairspring 43 itself.

Further, since the melting portion 60 is provided on both sides of the hairspring 43 in the axial direction, even if a size of each of the first melting portion 60A and the second melting portion 60B in the axial direction is small, it is possible to reduce a decrease in welding strength due to the wedge effect. Therefore, it is possible to adopt a configuration suitable for a case where the amount of heat input is limited when the melting portion 60 is formed.

In addition, since the melting portion 60 is provided on both sides of the hairspring 43 in the axial direction, it is possible to effectively reduce a decrease in welding strength even when a film of the paramagnetic hairspring 43 accumulates at an end of the melting portion 60 and a wedge effect is enhanced.

As described above, it is possible to provide the timepiece component 46 in which the paramagnetic hairspring 43 is welded to the collet 44 with high strength.

In the method for manufacturing the timepiece component 46 according to the present embodiment, the hairspring 43 is formed of a paramagnetic material, the collet 44 is provided with the pair of eaves portions 54 facing the hairspring 43 from both sides in the axial direction, and the pair of eaves portions 54 and the hairspring 43 are laser-welded to melt the collet 44 and the eaves portion 54, thereby fixing the collet 44 and the hairspring 43 to each other. According to the manufacturing method, the melting portion 60 in which each eaves portion 54 and the hairspring 43 are melted is formed on both sides of the hairspring 43 in the axial direction. Accordingly, compared to a configuration in which only one location of the hairspring 43 and the collet 44 are laser-welded, it is possible to increase a volume of the entire melting portion 60 while reducing an amount of heat input when the eaves portions 54 are laser-welded. Therefore, the above-described functions and effects can be achieved.

An oxide film is formed on the outer surface of the hairspring 43. According to this configuration, although the oxide film can accumulate at an end of the melting portion 60, even if the accumulated oxide acts to enhance the wedge effect, it is possible to reduce a decrease in welding strength of the hairspring 43 and the collet 44 by providing the melting portion 60 on both sides of the hairspring 43 in the axial direction.

The first melting portion 60A and the second melting portion 60B are separated from each other in the axial direction. According to this configuration, since the inner end portion 43a of the hairspring 43 is not divided by the melting portion 60, the melting portion 60 serves as an anchor in the hairspring 43 extending in the circumferential direction, and in particular, the strength of the hairspring 43 in a longitudinal direction can be improved.

The first melting portion 60A and the second melting portion 60B are each provided at one location in the circumferential direction with respect to the collet 44 and are continuous in the circumferential direction. According to this configuration, since each of the first melting portion 60A and the second melting portion 60B can be formed by one-time welding, it is possible to obtain the timepiece component 46 having excellent productivity.

In a configuration in which the melting portions are provided at a plurality of locations in the circumferential direction, the required welding strength of the hairspring and the collet can be ensured by being divided into a plurality of melting portions. On the other hand, in the present embodiment, since the melting portion 60 is provided at only one location in the circumferential direction, it is necessary to secure the welding strength required for the melting portion 60 at one location. Therefore, an effect of improving the welding strength of the hairspring 43 and the collet 44 can be effectively exhibited.

The melting portion 60 is located at a position opposite to the collet 44 with the inner end portion 43a interposed therebetween. According to this configuration, the inner end portion 43a of the hairspring 43 can be restricted from being displaced in a direction away from the collet 44 by the melting portion 60, and the hairspring 43 can be prevented from falling off from the collet 44. Therefore, the hairspring 43 can be firmly fixed to the collet 44.

The inner end portion 43a of the hairspring 43 has a gap in the radial direction with respect to the collet 44. In this configuration, compared to a configuration in which the inner end portion 43a of the hairspring 43 is in contact with the collet 44, there is room for the inner end portion 43a to be displaced with respect to the collet 44, and the inner end portion 43a is likely to fall off from the collet 44. Therefore, it is possible to effectively exhibit an effect of improving the welding strength of the hairspring 43 and the collet 44 and firmly fixing the hairspring 43 to the collet 44.

By disposing the eaves portion 54 to cover 70% or more of the inner end portion 43a of the hairspring 43 in the thickness direction of the inner end portion 43a when viewed from the axial direction at the time the collet 44 and the hairspring 43 are welded, the melted collet 44 can be overlapped over the entire thickness direction of the hairspring 43. Therefore, the welding strength of the hairspring 43 and the collet 44 can be improved.

By setting the width W in the circumferential direction at the base end portion of the eaves portion 54 to be equal to or more than 2 times and equal to or less than 10 times the thickness t of the hairspring 43 and setting the thickness T of each eaves portion 54 to be equal to or more than 0.5 times and equal to or less than 2 times the thickness t of the hairspring 43, it is possible to preferentially melt the eaves portion 54 when laser-welding is performed. If a dimension of each portion of the eaves portion 54 exceeds the above range, it takes time to melt the eaves portion 54, and the amount of heat input to the hairspring 43 may increase. If the dimension of each portion of the eaves portion 54 is below the above range, heat transfer from the eaves portion 54 to the hairspring 43 becomes excessive, and the amount of heat input to the hairspring 43 may increase. Therefore, by setting the dimension of each portion of the eaves portion 54 within the above range, the amount of heat input to the hairspring 43 can be reduced, and a decrease in the strength of the hairspring 43 itself can be reduced.

The collet 44 has a polygonal shape when viewed from the axial direction. According to this configuration, since the collet 44 is easily formed into a desired shape, a center of gravity of the collet 44 can be easily adjusted.

Since the movement 10 and the timepiece 1 according to the present embodiment include the timepiece component 46 described above, it is possible to provide the timepiece component 46 and the timepiece 1 with high reliability in which breakage of the balance with hairspring is prevented.

As shown in FIG. 9, in the timepiece component 46, an aggregate 70 formed by the oxide film of the hairspring 43 may be formed to be covered with the melting portion 60. The aggregate 70 is located, for example, between the hairspring 43 and the support surface 53a of the collet 44. Even if the aggregate 70 acts to enhance the wedge effect, it is possible to reduce a decrease in welding strength of the hairspring 43 and the collet 44 by providing the melting portion 60 on both sides of the hairspring 43 in the axial direction.

### Second Embodiment

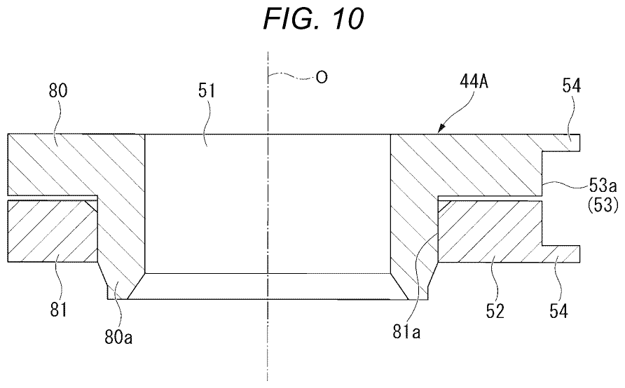

Next, a second embodiment will be described with reference to FIG. 10. The second embodiment is different from the first embodiment in that a collet 44A is formed such that an interval between the pair of eaves portions 54 can be changed. Configurations other than those to be described below are similar to those of the first embodiment.

FIG. 10 is a longitudinal sectional view of a collet according to the second embodiment.

As shown in FIG. 10, the collet 44A is formed such that the collet 44 according to the first embodiment can be divided in the axial direction. The collet 44A includes a first portion 80 and a second portion 81 that are coupled to each other. The relative positions of the first portion 80 and the second portion 81 in the axial direction are adjustable at least during assembly. The first portion 80 and the second portion 81 are formed in cooperation with the base portion 53 of the support portion 52. Each of the first portion 80 and the second portion 81 has one eaves portion 54. The materials forming the first portion 80 and the second portion 81 may be the same as or different from each other.

The first portion 80 includes a cylindrical portion 80a protruding toward the second portion 81 along the axial direction. The cylindrical portion 80a is formed in a cylindrical shape coaxial with the central axis O, and forms the outer fitting fixing portion 51 over the entire length in the axial direction. An insertion hole 81a penetrating in the axial direction is formed in the second portion 81. The cylindrical portion 80a is inserted into the insertion hole 81a, and the first portion 80 and the second portion 81 are coupled to each other. When the cylindrical portion 80a is inserted into the insertion hole 81a, relative displacement of the first portion 80 and the second portion 81 in a direction orthogonal to the axial direction is restricted. Further, the relative displacement of the first portion 80 and the second portion 81 in the axial direction is restricted, for example, by press-fitting the cylindrical portion 80a into the insertion hole 81a. The interval between the pair of eaves portions 54 can be changed by adjusting an amount of insertion of the cylindrical portion 80a into the insertion hole 81a.

In the present embodiment, effects similar to those of the first embodiment are achieved. In addition, in the present embodiment, the collet 44A includes the first portion 80 and the second portion 81 that are coupled to each other. The relative positions of the first portion 80 and the second portion 81 in the axial direction are adjustable. With this configuration, since the interval between the pair of eaves portions 54 can be changed according to a width of a hairspring, it is possible to provide a collet corresponding to a plurality of types of hairsprings having different widths. When the hairspring 43 and the collet 44A are welded, the interval between the pair of eaves portions 54 can be narrowed in a state where the inner end portion 43a of the hairspring 43 is disposed between the pair of eaves portions 54, and the eaves portions 54 can be brought into contact with the end edges of the hairspring 43. Therefore, the melting portion 60 can be reliably formed.

In the second embodiment, the cylindrical portion 80a has a cylindrical shape, and the cylindrical portion may have a rectangular tubular shape. In this case, the relative rotation of the first portion 80 and the second portion 81 can be restricted, and the collet 44A can be easily manufactured.

In the second embodiment, the cylindrical portion 80a is provided in the first portion 80, and the insertion hole 81a is formed in the second portion 81. Alternatively, a positional relation between the cylindrical portion and the insertion hole may be reversed.

### Third Embodiment

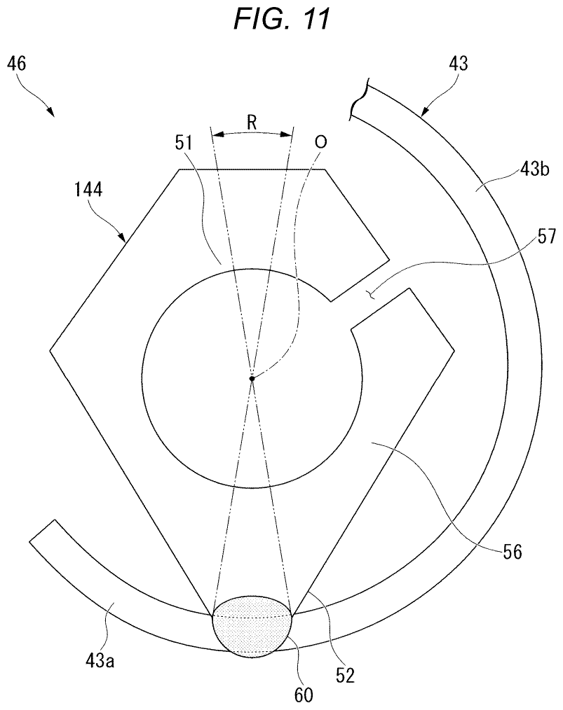

Next, a third embodiment will be described with reference to FIG. 11. The third embodiment is different from the first embodiment in that a slit is formed in a collet 144. Configurations other than those to be described below are similar to those of the first embodiment.

FIG. 11 is a plan view of a balance with hairspring according to the third embodiment.

As shown in FIG. 11, the collet 144 has a main body 56 extending along the circumferential direction around the balance staff 41 (see FIG. 3). The main body 56 extends less than 360° in the circumferential direction. A gap 57 that defines both ends of the main body 56 in the circumferential direction is formed in the collet 144. The gap 57 may be read as a slit. The gap 57 penetrates the collet 144 in the radial direction and the axial direction and allows communication between the inside and the outside of the collet 144 in the radial direction. The gap 57 extends at a regular interval.

The gap 57 is located at a position shifted about the balance staff 41 with respect to the melting portion 60. Further, the gap 57 is located at a position shifted by a predetermined angle from 180° about the balance staff 41 with respect to the melting portion 60. That is, the gap 57 is located at a position further shifted from an angular range R shifted by 180° about the central axis O with respect to the melting portion 60. In the present embodiment, the gap 57 is located at a position further shifted from 180° to less than 90° about the balance staff 41 with respect to the melting portion 60. The gap 57 penetrates, in the radial direction, a portion of the collet 144 where a thickness in the radial direction is minimized. In addition, a portion of the collet 144 shifted by 180° with respect to the gap 57 is a portion where the thickness in the radial direction is minimized.

In the present embodiment, effects similar to those of the first embodiment are achieved. In addition, in the present embodiment, the gap 57 that defines both ends of the main body 56 in the circumferential direction is formed in the collet 144. According to this configuration, by providing the gap 57 in the collet 144 in which the interference is set with respect to the balance staff 41, a pulling force and a loosening torque can be reduced to appropriate values. Therefore, the collet 144 can be easily attached to the balance staff 41, and the productivity of the movement 10 including the timepiece component 46 can be improved.

When the collet 144 provided with the gap 57 is fixed to the balance staff 41, the collet 144 may be eccentric to a side opposite to the gap 57 with respect to the balance staff 41, which is a rotation center thereof. In the present embodiment, the gap 57 is located at a position shifted from 180° by a predetermined angle with respect to the melting portion 60. According to this configuration, even when the collet 144 is eccentric to the rotation center (central axis O), the inner end portion 43a of the hairspring 43 is less likely to be displaced in the radial direction. Accordingly, it is possible to prevent occurrence of an error in isochronism of the hairspring 43. Further, the gap 57 is shifted about the balance staff 41 with respect to the melting portion 60. Accordingly, since the gap 57 is provided to avoid the melting portion 60, the stress generated in the collet 144 when the collet 144 is fixed to the balance staff 41 is unlikely to affect the melting portion 60. Therefore, it is possible to reduce a decrease in a fixing force of the collet 144 and the hairspring 43 in the melting portion 60.

The collet 144 has a polygonal shape when viewed from the axial direction. According to this configuration, since the collet 144 is easily formed into a desired shape, a center of gravity of the collet 144 can be easily adjusted. In particular, in the present embodiment, the collet 144 is provided with the gap 57, and the gap 57 is located at a position shifted by a predetermined angle from 180° about the balance staff 41 with respect to the melting portion 60, and thus there is no symmetry in the plan view shape of the collet 144. Therefore, an effect of facilitating the adjustment of the center of gravity of the collet 144 can be effectively exhibited.

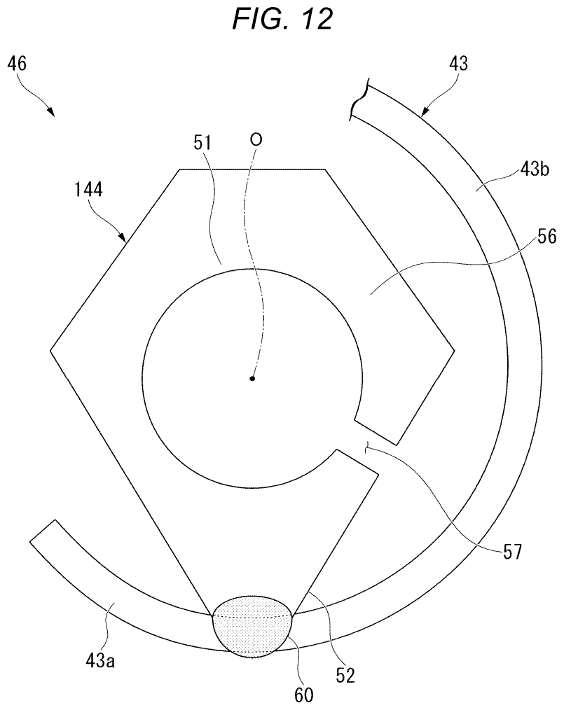

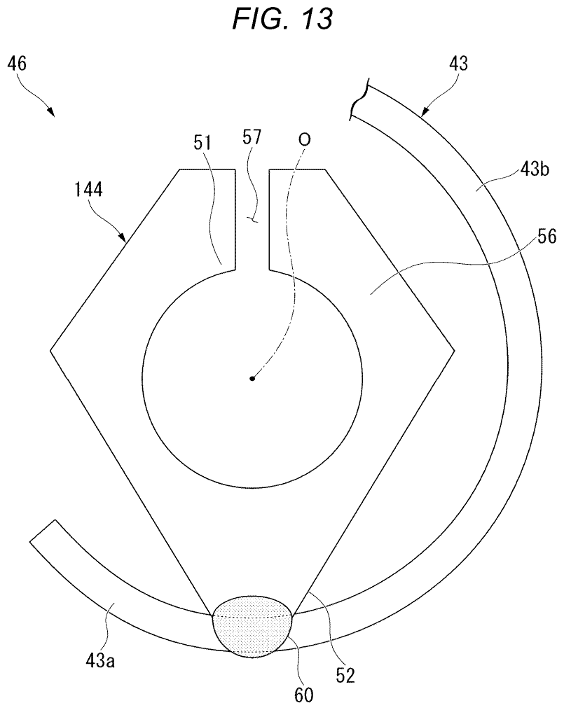

In the third embodiment, the gap 57 is located at a position further shifted from 180° to less than 90° about the balance staff 41 with respect to the melting portion 60. However, as shown in FIG. 12, the gap 57 may be located at a position further shifted by 90° or more from 180° about the balance staff 41 with respect to the melting portion 60. In addition, as shown in FIG. 13, the gap 57 may be located at a position shifted by 180° about the balance staff 41 with respect to the melting portion 60.

### Fourth Embodiment

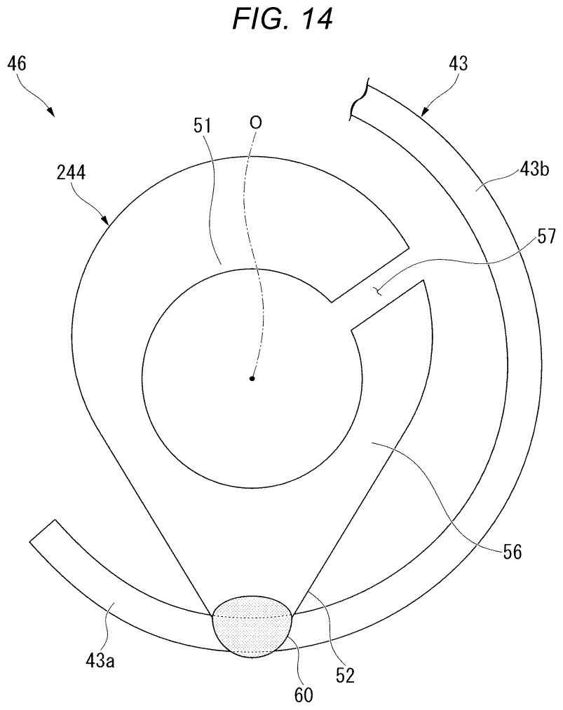

Next, a fourth embodiment will be described with reference to FIG. 14. The fourth embodiment is different from the third embodiment in that a collet 244 has a droplet shape when viewed from the axial direction. Configurations other than those to be described below are similar to those of the third embodiment.

FIG. 14 is a plan view of a balance with hairspring according to the fourth embodiment.

As shown in FIG. 14, an outer shape of the collet 244 is a droplet shape having the melting portion 60 (support portion 52) as a vertex when viewed from the axial direction. The gap 57 of the collet 244 is located at a position shifted about the balance staff 41 with respect to the melting portion 60. Further, the gap 57 is located at a position shifted by a predetermined angle from 180° about the balance staff 41 with respect to the melting portion 60. In the present embodiment, the gap 57 is located at a position further shifted from 180° to less than 90° about the balance staff 41 with respect to the melting portion 60.

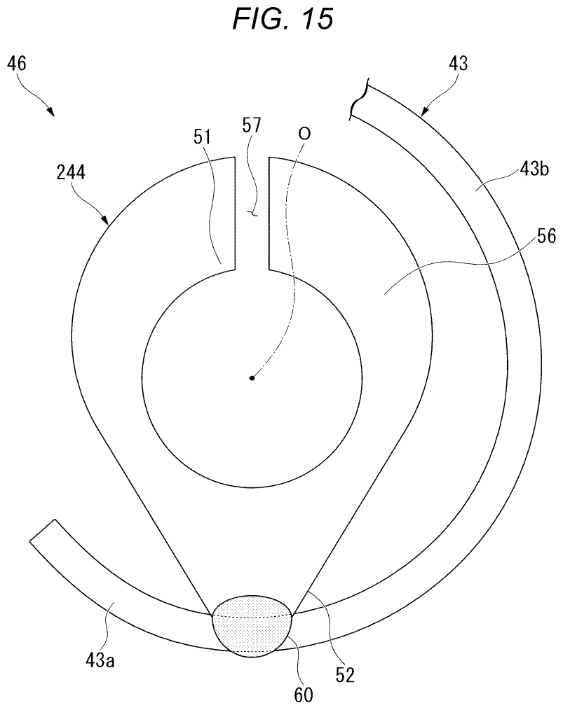

In the present embodiment, effects similar to those of the third embodiment are achieved. As shown in FIG. 15, in the droplet collet 244, the gap 57 may be at a position shifted by 180° about the balance staff 41 with respect to the melting portion 60.

The invention is not limited to the embodiments described above with reference to the drawings, and various modifications are conceivable within the technical scope of the invention.

For example, in the above embodiments, the melting portion 60 is disposed in the region on the outer side in the radial direction of the inner end portion 43a of the hairspring 43, but the invention is not limited to this configuration. That is, at least one of the first melting portion and the second melting portion may not be disposed in the region on the outer side in the radial direction of the inner end portion 43a of the hairspring 43.

In the above embodiment, the first melting portion 60A and the second melting portion 60B are separated from each other in the axial direction. Alternatively, portions of the first melting portion and the second melting portion may be continuous with each other.

In the above embodiments, although a niobium alloy is used as an example of the paramagnetic material for forming the hairspring 43, the paramagnetic material for forming the hairspring is not limited to a niobium alloy, and any material having a melting point exceeding 1800° C. can effectively exert the above-described functions and effects.

In addition, the components in the above-described embodiments can be appropriately replaced with well-known components without departing from the gist of the invention, and the above-described embodiments and modifications may be appropriately combined.

What is claimed is:

1. A timepiece component comprising:
a collet fixed to a balance staff;
a hairspring formed of a paramagnetic material and including a fixed portion fixed to the collet; and
a melting portion in which the collet and the hairspring are melted to fix the collet and the fixed portion to each other, wherein
the melting portion includes
a first melting portion provided at a position on a first side in an axial direction with respect to the fixed portion, and
a second melting portion provided at a position on a second side in the axial direction with respect to the fixed portion.

2. The timepiece component according to claim 1, wherein
an oxide film is formed on an outer surface of the hairspring.

3. The timepiece component according to claim 1, wherein
the first melting portion and the second melting portion are separated from each other in the axial direction.

4. The timepiece component according to claim 1, wherein
the melting portion is provided at one location in a circumferential direction with respect to the collet, and
the first melting portion and the second melting portion are each continuous in the circumferential direction.

5. The timepiece component according to claim 1, wherein
the melting portion is located at a position opposite to the collet with the fixed portion interposed therebetween.

6. The timepiece component according to claim 1, wherein
the fixed portion has a gap in a radial direction with respect to the collet.

7. The timepiece component according to claim 2, further comprising:
an aggregate formed of the oxide film and covered with the melting portion.

8. The timepiece component according to claim 1, wherein
the collet includes a main body extending along a circumferential direction around the balance staff, and
a gap defining both ends of the main body in the circumferential direction is formed in the collet.

9. The timepiece component according to claim 8, wherein
the gap is shifted with respect to the melting portion around the balance staff and is located at a position shifted by a predetermined angle from 180° with respect to the melting portion.

10. The timepiece component according to claim 8, wherein
the collet has a polygonal shape when viewed from the axial direction.

11. A timepiece movement comprising:
the timepiece component according to claim 1.

12. A timepiece comprising:
the timepiece movement according to claim 11.

13. A method for manufacturing a timepiece component, the timepiece component including a collet fixed to a balance staff and a hairspring fixed to the collet, the method comprising:
forming the hairspring using a paramagnetic material;
providing, on the collet, a pair of eaves portions facing the hairspring from both sides in an axial direction; and
fixing the collet and the hairspring to each other by melting the collet and the eaves portions by laser-welding the pair of eaves portions and the hairspring.
